(19) United States
(12) Patent Application Publication
(10) Pub. No.: US 2006/0048088 A1
(43) Pub. Date: Mar. 2, 2006

(54) Computer automated design method, program for executing an application on a computer automated design system, and semiconductor integrated circuit

(76) Inventor: Mikio Nakano, Kawasaki-shi (JP)

Correspondence Address: DLA PIPER RUDNICK GRAY CARY US, LLP, 2000 UNIVERSITY AVENUE, E. PALO ALTO, CA, 94303-2248, US

(21) Appl. No.: 11/210,074

(22) Filed: Aug. 22, 2005

(30) Foreign Application Priority Data
Aug. 24, 2004 (JP) P2004-244069

(51) Int. Cl. G06F 17/50

(52) U.S. Cl. 716/12

(57) ABSTRACT

A computer automated design method includes defining rectangular areas serving as a starting point area and an ending point area of a wiring; accumulating wiring costs whenever an exploration of a wiring path from the starting point area to the ending point area advances one rectangular area, multiplying the wiring cost by a via cost and adding an obstacle cost; finding a final wiring path routing through a plurality of wiring areas to connect the starting point area and the ending point area; and arranging the corresponding multiple cut via.

### CROSS REFERENCE TO RELATED APPLICATIONS AND INCORPORATION BY REFERENCE

This application is based upon and claims the benefit of priority from the prior Japanese Patent Applications No. P2004-244069, filed on Aug. 24, 2004; the entire contents of which are incorporated herein by reference.

### BACKGROUND OF THE INVENTION

1. Field of the Invention

The present invention relates to a layout design methodology for a semiconductor integrated circuit, more specifically to a layout design methodology for wiring processes.

2. Description of the Related Art

In the field of layout design of semiconductor integrated circuits, a maze routing is known as a method of obtaining a wiring path between two points. The maze routing is a wiring path finding method configured to set a grid (lattice) on a plane subject to wiring, and to find a path for connecting between two rectangular areas which are divided by the grid. Even when there is an obstacle such as an existing line, the maze routing can find a wiring path to bypass such an obstacle. The maze routing is widely used for detailed routing after global routing, and the like.

In the field of manufacturing semiconductor integrated circuits, along with increasing demands for downsizing and higher integration, it has become more difficult to form wiring shapes for connecting between elements in accordance with the original design. For example, as the wiring is downsized, a phenomenon that a line does not reach a position of a via for connecting upper and lower wiring layers (shortening), and the like are apt to occur more frequently. Accordingly, faulty connection and an increase in resistance of vias are incurred and product yields are thereby reduced.

To prevent a reduction in yields attributable to defective vias, a method of replacing one via (a single cut via) for connecting lines with a plurality of vias (multiple cut vias) has been proposed. However, the method generally used today is applied as a post process after designing the wiring. Accordingly, it is not taken into consideration in the method that are placement with multiple cut vias can be made in the course of designing the wiring. Therefore, there are numerous areas in which the single cut vias cannot be replaced with the multiple cut vias due to the design, and it is not possible to improve the rate of replacement with the multiple cut vias.

### SUMMARY OF THE INVENTION

An aspect of the present invention inheres in a computer automated design method encompassing: defining rectangular areas serving as a starting point area and an ending point area of a wiring, the rectangular areas being selected from wiring areas assigned in a plurality of layers, each of layers being divided into a plurality of areas by a lattice; accumulating wiring costs by adding respective wiring cost whenever an exploration of a wiring path from the starting point area to the ending point area advances one rectangular area, multiplying the wiring cost by a via cost, when a multiple cut via is provided between the wiring areas assigned in two of the layers in the plurality of layers, and adding an obstacle cost based on obstacle information to a result of multiplication of the via cost; finding a final wiring path routing through a plurality of wiring areas in the two of layers based on a value obtained by accumulating the wiring costs to connect the starting point area and the ending point area; and arranging corresponding multiple cut via in the final wiring path connecting areas in the two of layers.

Another aspect of the present invention inheres in a program configured to be executed by a computer for executing an application on a computer automated design system, comprising: defining rectangular areas serving as a starting point area and an ending point area of a wiring, the rectangular areas being selected from wiring areas assigned in a plurality of layers, each of layers being divided into a plurality of areas by a lattice; accumulating wiring costs by adding respective wiring cost whenever an exploration of a wiring path from the starting point area to the ending point area advances one rectangular area, multiplying the wiring cost by a via cost, when a multiple cut via is provided between the wiring areas assigned in two of the layers in the plurality of layers, and adding an obstacle cost based on obstacle information to a result of multiplication of the via cost; finding a final wiring path routing through a plurality of wiring areas in the two of layers based on a value obtained by accumulating the wiring costs to connect the starting point area and the ending point area; and arranging the corresponding multiple cut via in the final wiring path connecting areas in the two of layers.

Still another aspect of the present invention inheres in a semiconductor integrated circuit manufactured by using a computer automated design method, the method comprising: defining rectangular areas serving as a starting point area and an ending point area of a wiring, the rectangular areas being selected from wiring areas assigned in a plurality of layers, each of layers being divided into a plurality of areas by a lattice; accumulating wiring costs by adding respective wiring cost whenever an exploration of a wiring path from the starting point area to the ending point area advances one rectangular area, multiplying the wiring cost by a via cost, when a multiple cut via is provided between the wiring areas assigned in two of the layers in the plurality of layers, and adding an obstacle cost based on obstacle information to a result of multiplication of the via cost; finding a final wiring path routing through a plurality of wiring areas in the two of layers based on a value obtained by accumulating the wiring costs to connect the starting point area and the ending point area; and arranging the corresponding multiple cut via in the final wiring path connecting areas in the two of layers.

### BRIEF DESCRIPTION OF DRAWINGS

FIG. 1 is a block diagram illustrating a computer automated design system according to the first embodiment of the present invention.

FIGS. 2 and 3 are flowcharts illustrating a computer automated design method according to the first embodiment of the present invention.

FIGS. 4A, 4B, 5A, 5B, 6A, 6B, 7A, 7B, 8A, 8B, 9A and 9B are CAD data illustrating a method of finding a wiring path of the computer automated design method according to the first embodiment of the present invention.

FIG. 10 is a schematic diagram illustrating the computer automated design method according to the first embodiment of the present invention.

FIGS. 11A and 11B are plan views illustrating an example of a semiconductor integrated circuit designed by the computer automated design method according to the first embodiment of the present invention.

FIG. 12 is a cross-sectional view taken on line XII-XII in FIGS. 11A and 11B.

FIG. 13 is a cross-sectional view taken on line XIII-XIII in FIGS. 11A and 11B.

FIG. 14 is a block diagram illustrating a computer automated design system according to a second embodiment of the present invention.

FIG. 15 is CAD data illustrating a computer automated design method according to the second embodiment of the present invention.

FIGS. 16 and 17 are flowcharts illustrating the computer automated design method according to the second embodiment of the present invention.

FIGS. 18A, 18B, 19A, 19B, 20A and 20B are CAD data illustrating a method of finding a wiring path of the computer automated design method according to the second embodiment of the present invention.

FIG. 21 is a block diagram illustrating a computer automated design system according to a third embodiment of the present invention.

FIG. 22 is a flowchart illustrating a computer automated design method according to the third embodiment of the present invention.

FIGS. 23 and 24 are CAD data illustrating a computer automated design method according to the third embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified. In the following descriptions, numerous details are set forth such as specific signal values, etc. to provide a thorough understanding of the present invention. However, it will be obvious to those skilled in the art that the present invention may be practiced without such specific details.

### First Embodiment

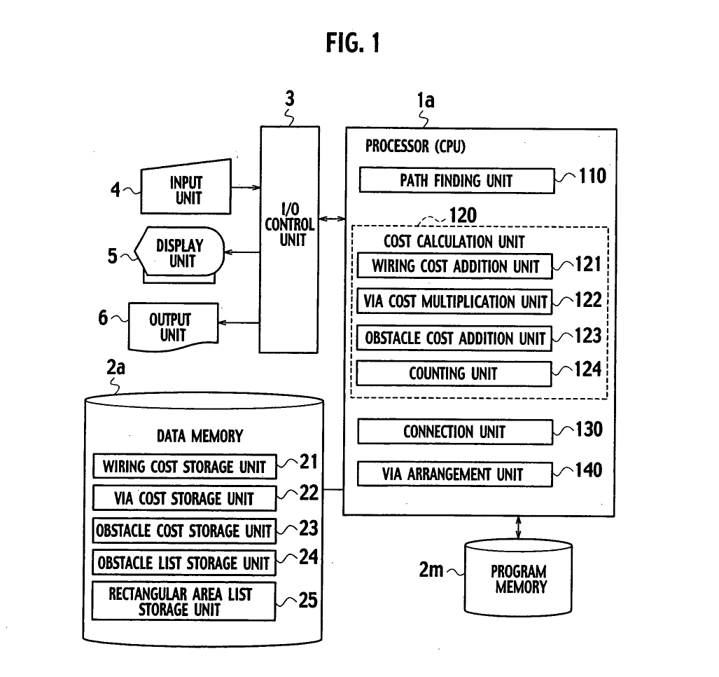

As shown in FIG. 1, a computer automated design system according to a first embodiment of the present invention includes an input unit 4 which inputs information such as data or instructions from an operator, a central processing unit (CPU) 1a which executes various calculations such as layout design, a display unit 5 and an output unit 6 which output a layout result and the like, a data memory 2a which stores given data and the like necessary for layout design of a semiconductor integrated circuit, and a program memory 2m which stores a layout program and the like for the semiconductor integrated circuit. The input unit 4, the display unit 5, and the output unit 6 are connected to the CPU 1a through an input and output control unit 3.

The CPU 1a automatically provides lines in a plurality of layers and vias for connecting between the lines onto a chip area of a semiconductor integrated circuit which is located virtually inside a memory space of the computer automated design system. The CPU 1a shown in FIG. 1 includes a path finding unit 110, a cost calculation unit 120, a connection unit 130, and a via arrangement unit 140.

As shown in FIGS. 4A and 4B, the path finding unit 110 finds a wiring path by use of the maze routing, which achieves the lowest cost for connecting lattice spaces between a starting point area S being a starting point of a wiring and an ending point area E being an ending point of the wiring in a plurality of layers of wiring areas divided into a plurality of rectangular areas by a lattice (grid). The cost calculation unit 120 calculates a cost corresponding to an environment of a rectangular area subject to exploration every time the path finding unit 110 advances one rectangular area through the exploration of the wiring path. As shown in FIG. 1, the cost calculation unit 120 includes a wiring cost addition unit 121, a via cost multiplication unit 122, an obstacle cost addition unit 123, and a counting unit 124.

The wiring cost addition unit 121 adds a wiring cost at each time of advancing one rectangular area through the exploration of the wiring path between the two rectangular areas. The via cost multiplication unit 122 multiplies the wiring cost by a via cost for providing a plurality of vias in any of different layers, when an exploration is performed in the different layers. The obstacle cost addition unit 123 adds an obstacle cost based on information on an obstacle located around the rectangular area subject to exploration, when the exploration is performed in the different layers. The counting unit 124 counts up the costs calculated by the wiring cost addition unit 121, the via cost multiplication unit 122, and the obstacle cost addition unit 123.

For example, in terms of the layouts shown in FIGS. 4A and 4B, the following in formation is input as the costs for allowing the wiring cost addition unit 121, the via cost multiplication unit 122, and the obstacle cost addition unit 123, respectively, to calculate the wiring path.

Wiring cost for advancing one rectangular area in a horizontal direction in a wiring area in a first layer: 1

Wiring cost for advancing one rectangular area in a vertical direction in the wiring area in the first layer: 4

Wiring cost for advancing one rectangular area in a horizontal direction in a wiring area in a second layer: 4

Wiring cost for advancing one rectangular in a vertical direction in the wiring area in the second layer: 1

Wiring cost for advancing one rectangular area to a wiring area in a different layer: 2

Via cost for arranging multiple cut vias: 2

Obstacle cost for an obstacle O existing in any of rectangular areas adjacent to four sides defining a rectangular area subject to exploration: 1 Here the “horizontal direction” indicates the right-to-left direction in the page spaces of FIGS. 4A to 9B, and the “vertical direction” indicates the top-to-bottom direction in the page spaces of FIGS. 4A to 9B. In FIGS, 4A and 4B, horizontal direction in the first layer is set to be a wiring preferential direction. Vertical direction in the second layer is set to be the wiring preferential direction. Codes 1 to 7 are allocated in the horizontal direction of each rectangular area, and codes A to Fare allocated in the vertical direction thereof. In the following, position information on each rectangular area will be indicated in the order of “a rectangular area (position in the horizontal direction—position in the vertical direction—wiring layer)”.

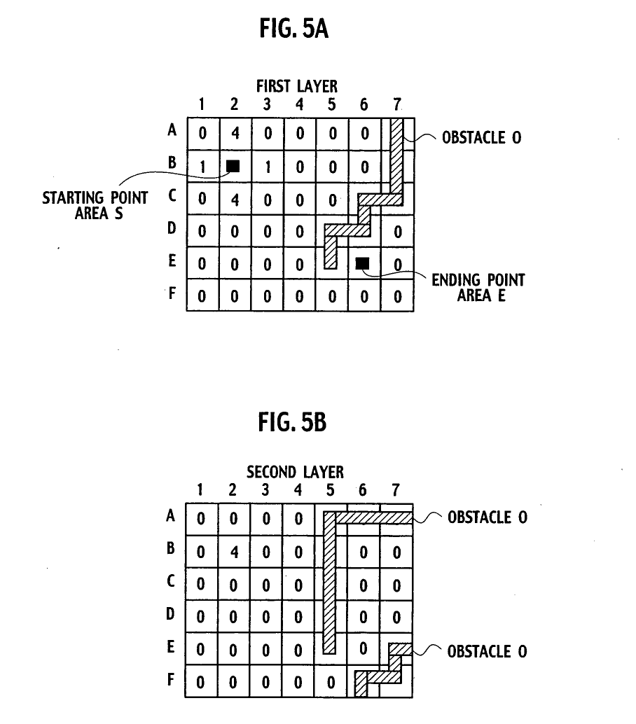

As shown in FIG. 4A, when information on the positions of the two points on the starting point area S and the ending point area E is input, the exploration of the wiring path to advance one rectangular area in the left direction from the starting point area (B-2-1) to the rectangular area (B-1-1) corresponds to the above-described “wiring cost for advancing one rectangular area in the horizontal direction in the wiring area in the first layer”. For this reason, the wiring cost addition unit 121 adds the wiring cost “1” for the rectangular area (B-1-1). Meanwhile, an exploration from the rectangular area (B-2-1) to the rectangular area (B-1-1) is equivalent to an exploration of wiring in the same wiring layer, and it is not necessary to form a via. For this reason, the via cost multiplication unit 122 does not multiply the rectangular area (B-1-1) by the via cost. As a result, the counting unit 124 counts “1”, which is obtained by adding only the wiring cost “1” to the cost “0” of the starting point area S, as the cost of the rectangular area (B-1-1). As a consequence, the information on the cost “1” is stored in the area of the rectangular area (B-1-1) as shown in FIG. 5A.

An exploration to advance one rectangular area in the upper direction from the rectangular area (B-2-1) to the rectangular area (A-2-1) corresponds to the “wiring cost for advancing one rectangular area in the vertical direction in the wiring area in the first layer”. For this reason, the wiring cost addition unit 121 adds the wiring cost “4” for the rectangular area (A-2-1). The exploration from the rectangular area (B-2-1) to the rectangular area (A-2-1) is not an exploration to a different layer. Here, no obstacles O such as an existing line exist around the rectangular area (A-2-1). For this reason, the obstacle cost addition unit 123 does not add the obstacle cost for the rectangular area (A-2-1). As a result, the counting unit 124 counts a value of the cost “4”, which is obtained by adding the wiring cost “4” to the cost “0” of the starting point area S, and stores the information on “4” in the area of the rectangular area (A-2-1) as shown in FIG. 5A.

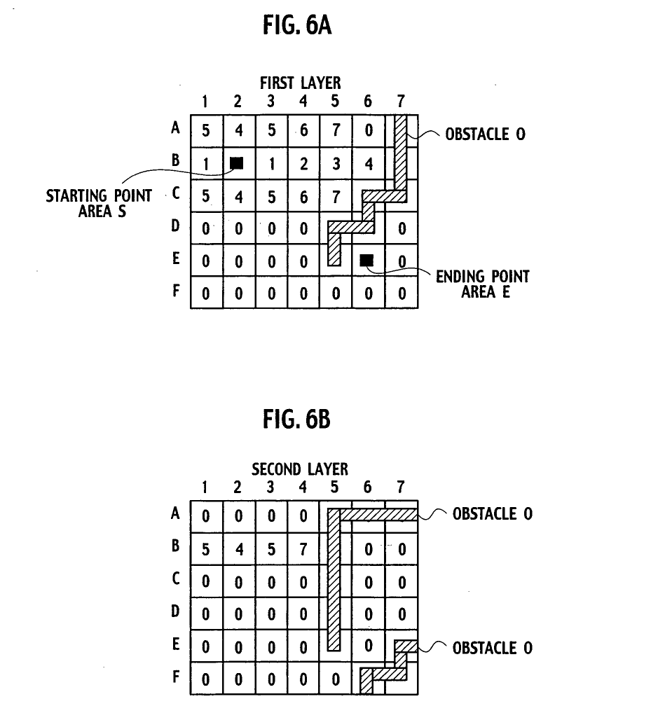

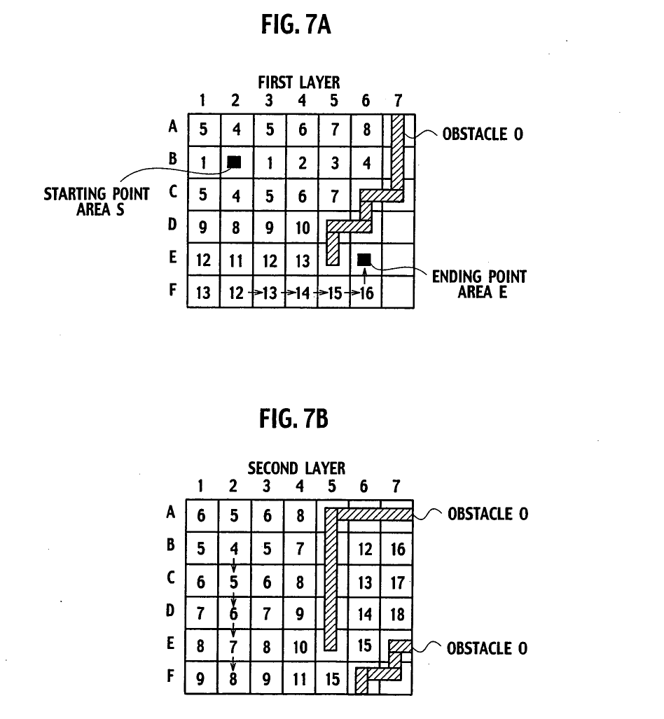

A case of performing an exploration to advance one rectangular area in the direction of an upper layer from the rectangular area (B-2-1) to the rectangular area (B-2-2) corresponds to the “wiring cost for advancing one rectangular area to a wiring area in a different layer”. For this reason, the wiring cost addition unit 121 adds the wiring cost “2” for the rectangular area (B-2-2). The exploration from the rectangular area (B-2-1) to the rectangular area (B-2-2) is an exploration to a different layer, and it is therefore necessary to form a via. The via cost multiplication unit 122 multiplies the wiring cost “2” by the cost value “2” as the via cost for disposing a multiple cut via and thereby calculates the value “4”. Consequently, the counting unit 124 sets, as a counting result, a cost value “4”, which is obtained by adding the multiplication result “4” found by the via cost multiplication unit 122 to the cost “0” of the starting point area S, and stores the information on “4” as shown in FIG. 5B. When the costs are sequentially calculated starting from the rectangular areas around the starting point area S as shown in FIGS. 6A and 6B, the costs of almost all the wiring areas are calculated in the end as shown in FIGS. 7A and 7B.

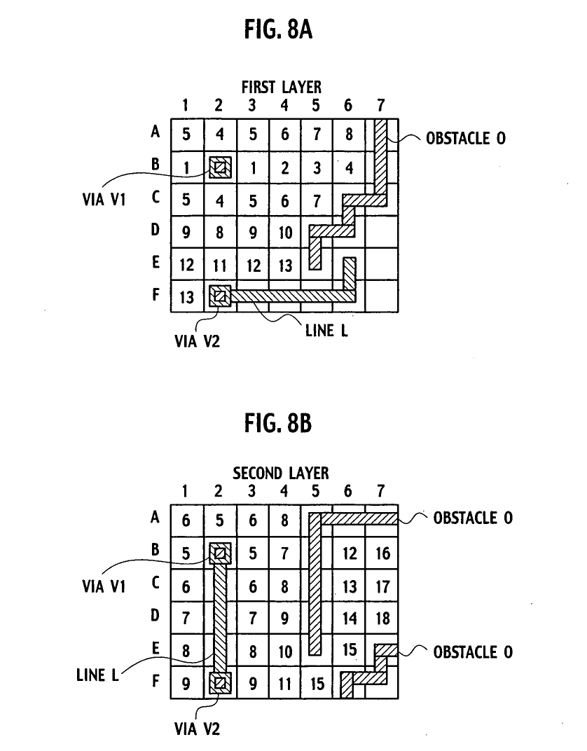

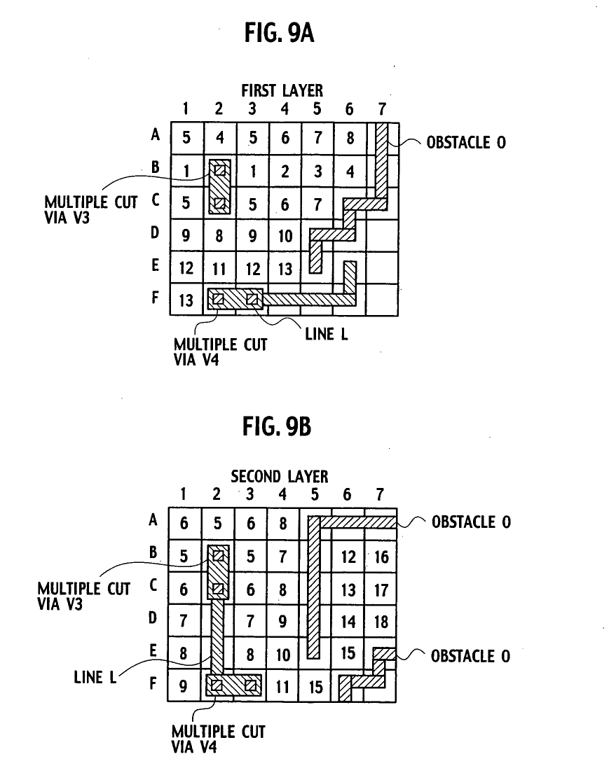

The connection unit 130 of FIG. 1 connects lines to form a wiring path (which is indicated with arrows in FIGS. 7A and 7B) achieving the lowest cost, which is explored by the path finding unit 110, based on the costs calculated by the cost calculation unit 120. In this way, a line L is installed in the wiring areas provided inside the memory space as shown in FIGS. 8A and 8B. The via arrangement unit 140 arranges vias (single cut vias V1 and V2) for connecting between the lines in the first and second layers or alternatively, arranges a plurality of vias (multiple cut vias V3 or V4) as shown in FIGS. 9A and 9B.

The data storage unit 2a of FIG. 1 includes a wiring cost storage unit 21, a via cost storage unit 22, an obstacle cost storage unit 23, an obstacle list storage unit 24, and a rectangular area list storage unit 25. The wiring cost storage unit 21 stores information on the wiring costs, which can be set up by the input unit 4 and the like in response to an exploration request for the wiring path such as a preferential wiring direction. The via cost storage unit 22 stores information on the via costs, which can be set up by the input unit 4 and the like in response to the number, shapes, sizes and the like of the vias. The obstacle cost storage unit 23 stores information on the obstacle costs, which can be set up by the input unit 4 and the like in response to an obstacle such as an existing line existing around the rectangular area subject to exploration. The obstacle list storage unit 24 stores a list of obstacles including lines which have already been installed in the wiring areas in the memory space, and the like. The rectangular area list storage unit 25 stores the information on an origin area which is an origin of finding path in the wiring areas, and the cost information in the rectangular areas around the origin area, which are calculated by the cost calculation unit 120, and the like.

In FIG. 1, the input unit 4 includes a keyboard, a mouse, a light pen, a flexible disk drive, and the like. An operator can designate input and output data or set up numerical values and the like which are necessary for automated design by use of the input unit 4. It is also possible by use of the input unit 4 to set layout parameters such as an output data format, or to input instructions on execution and abortion of calculation. The display unit 5 and the output unit 6 respectively include a display unit, a printer device and the like. The display unit 5 displays the input and output data, a layout result and the like. The program memory 2m stores the input and output data, the layout parameters, histories thereof, data in the course of calculation and the like.

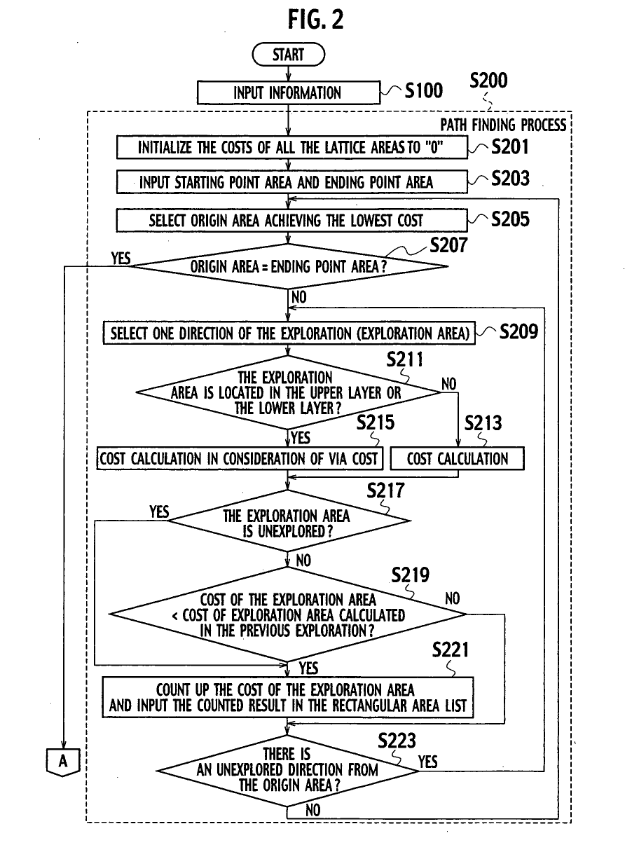

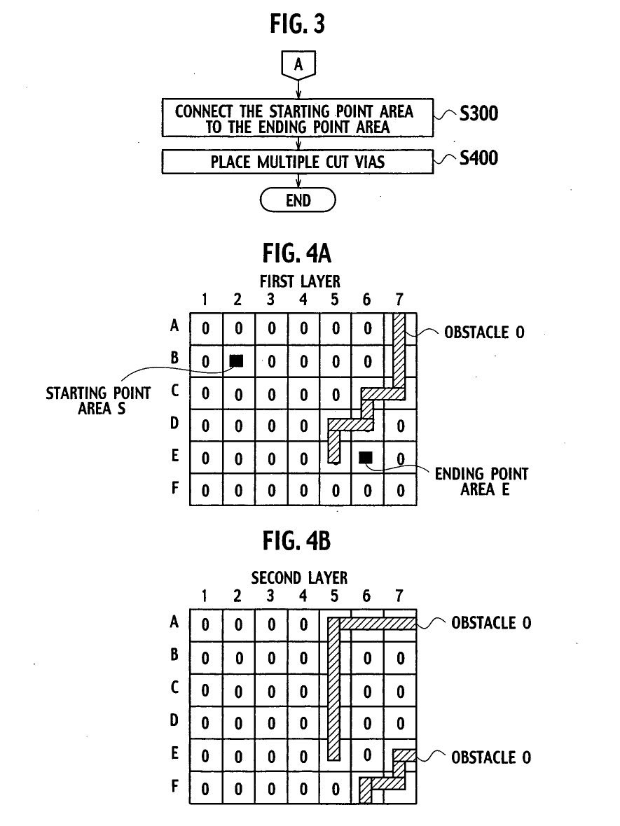

Next, a computer automated design method according to the first embodiment will be described in detail with reference to flowcharts shown in FIGS. 2 and 3 and to FIGS. 4A to 9B.

(a) In Step S100 of FIG. 2, the various information, which is necessary for the computer automated design system shown in FIG. 1 to execute an automated design process, is input by use of the input unit 4. For example, pieces of information on the wiring costs, the via costs and the obstacle costs used for calculation by the cost calculation unit 120 shown in FIG. 1 are input, and are stored in the wiring cost storage unit 21, the via cost storage unit 22, and the obstacle cost storage unit 23, respectively.

(b) In Step S200, a path finding process for the wiring is performed in accordance with the maze routing. In Step S201, the costs of all the lattice areas divided by the grid are initialized to “0”. As shown in FIGS. 4A and 4B, in Step S203, information on the starting point area S constituting the starting point of the exploration and information on the ending point area E constituting the ending point of the exploration are stored in the rectangular area list storage unit 25 of FIG. 1 by use of the input unit 4 and the like. Here, information on the position of the rectangular area (B-2-1) is stored as the starting point area S and information on the position of the rectangular area (E-6-1) is stored as the ending point area E, for example.

(c) In Step S205 the path finding unit 110 of FIG. 1 selects an origin area M achieving the lowest cost based on the information stored in the rectangular area list storage unit 25 to find a wiring path. In the example shown in FIGS. 4A and 4B, the rectangular area list storage unit 25 stores only the information on the starting point area S and the ending point area E. For this reason, the path finding unit 110 selects the starting point area S, namely the rectangular area (B-2-1), as the origin area M. Subsequently, in Step S207, the path finding unit 110 judges whether or not the origin area M coincides with the ending point area E. Since the rectangular area (B-2-1) of the origin area M is different from the rectangular area (E-6-1) of the ending point area E, the process goes to Step S209.

(d) In Step S209, the path finding unit 110 selects one direction of the exploration (an exploration area P) to be started from the origin area M. In FIGS. 4A and 4B, any one of the right direction, the left direction, the upper direction, the lower direction, and the direction to the upper layer is conceivable as the direction of the exploration to be started from the rectangular area (B-2-1). Here, the right direction will be selected as the exploration area P. As a result, the rectangular area (B-3-1) becomes the exploration area. In Step S211, the cost calculation unit 120 judges whether or not the exploration area P is located in the upper layer or the lower layer. When the exploration area P is located in the upper layer or the lower layer, the process goes to Step S215. When the exploration area P is not located in the upper layer or the lower layer, the process goes to Step S213.

As shown in FIGS. 4A and 4B, since the rectangular area (B-3-1) is not located in the upper layer or the lower layer relative to the rectangular area (B-2-1) which is the origin area M, the process goes to Step S213.

(e) In Step S213, the wiring cost calculation unit 121 calculates the wiring cost based on the information stored in the wiring cost storage unit 21. As shown in FIGS. 4A and 4B, the rectangular area (B-3-1) incurs the “wiring cost for advancing one rectangular area in the horizontal direction in a wiring area in a first layer from the viewpoint of the rectangular area (B-2-1). Therefore, the wiring cost addition unit 121 adds the cost “1” and stores the cost in the program memory 2m.

(f) In Step S217, the cost calculation unit 120 judges whether or not the exploration area P is unexplored. The process goes to Step S221 when the exploration area P is unexplored, and the process goes to Step S219 when the exploration area P is not unexplored. Since the rectangular area (B-3-1) is unexplored at this point, the process goes to Step S221. In Step S221, the counting unit 124 counts up the wiring cost of the exploration area P and the like stored in the program storage unit 2m, adds a counting result to the cost of the origin area M, and stores the added value in the rectangular area list storage unit 25. The cost of the rectangular area (B-3-1) is equal to “1” which is obtained by adding the wiring cost “1” the obstacle cost “0”, and the value “0” of the starting point area S together. For this reason, as shown in FIG. 5A, the counting unit 124 stores the value “1” in an area of the rectangular area list storage unit 25, the area corresponding to the rectangular area (B-3-1).

(g) In Step S223, the path finding unit 110 judges whether or not there is an unexplored direction from the origin area M. The process goes to Step S209 when there is an unexplored direction, and the process goes to Step S205 when there is not an unexplored direction. Since the rectangular area (B-3-1) is the only area which has been explored as the exploration area P at this point, the process goes to Step S209. In Step S209, the path finding unit 110 selects another direction of the exploration (the exploration area P) to be started from the origin area M. Here, the path finding unit 110 is assumed to select the rectangular area (B-2-2) in the direction of the upper layer as the direction of the exploration from the rectangular area (B-2-1). In Step S211, the cost calculation unit 120 judges whether or not the exploration area P is located in the upper layer or the lower layer. Since the rectangular area (B-2-2) corresponds to an exploration in the direction of the upper layer, the process goes to Step S215.

(h) In Step S215, the wiring cost calculation unit 121 calculates the cost based on the information stored in the wiring cost storage unit 21. Since the rectangular area (B-2-2) incurs the “wiring cost for advancing one rectangular area to a different layer” from the viewpoint of the rectangular area (B-2-1), the wiring cost addition unit 121 adds the cost “2” and stores the cost in the program memory 2m. Subsequently, the via cost multiplication unit 122 multiplies the value, which is added by the wiring cost addition unit 121, by the via cost based on the information stored in the via cost storage unit 22. Here, the via cost stored in the via cost storage unit 22 is equal to “2”. Accordingly, the via cost multiplication unit 122 multiplies the value “2” added by the wiring cost addition unit 121 by the via cost “2”, and stores the information on the cost “4” in the program storage unit 2m. Moreover, the obstacle cost addition unit 123 adds the obstacle cost existing around the exploration area P based on the information stored in the obstacle cost storage unit 23. Here, since there exists no obstacle around the exploration area P, the obstacle cost is equal to “0”. The obstacle cost addition unit 123 stores the information “0” in the program memory 2m.

(i) In Step S217, the cost calculation unit 120 judges whether or not the exploration area P is unexplored. Since the rectangular area (B-2-2) is unexplored, the process goes to Step S221. In Step S221, the counting un it 124 counts each cost of the exploration area P calculated by the cost calculation unit 120 to the cost of the origin area M, and stores the added value in the rectangular area list storage unit 25. Here, the cost of the rectangular area (B-2-2) stored in the rectangular area list storage unit 25 is equal to ”4”, which is obtained by adding the value “0” of the starting point area S, the value “4” found by multiplying the wiring cost by the via cost, and the obstacle cost “0”0 together. As shown in FIG. 5B, the counting unit 124 stores the information on the cost “4” in an area of the rectangular area list storage unit 25, the area corresponding to the rectangular area (B-2-2).

(j) In Step S223, the path finding unit 110 judges whether or not there is an unexplored direction from the origin area M. Since the rectangular area (B-3-1) and the rectangular area (B-2-2) are the only areas explored as the exploration areas P at this point and there exist unexplored directions, the process goes to Step S209. Likewise, each of the Steps S209 to S223 is repeated, and the costs of all the rectangular areas around the origin area M are stored in the rectangular area list storage unit 25.

(k) When a judgment is made in Step P223 that all the exploration areas P have been explored, the process goes to Step S205 and the path finding unit 110 explores a new origin area M. In the example shown in FIG. 5A, the cost information is stored in five areas of the rectangular area (A-2-1), the rectangular area (B-1-1), the rectangular area (B-3-1), the rectangular area (C-2-1), and the rectangular area (B-2-2). Here, since the area achieving the lowest cost is either the rectangular area (B-1-1) or the rectangular area (B-3-1), which represents the cost “1” Accordingly, either one of these rectangular areas is selected. In this case, the rectangular area (B-3-1) is selected as the new origin area M.

(l) In Step S207, the path finding unit 110 judges whether or not the origin area M coincides with the ending point area E. Since the rectangular area (B-3-1) of the origin area M is different from the rectangular area (E-6-1) of the ending point area E, the process goes to Step S209. In Step S209, the path finding unit 110 selects one direction of the exploration to be started from the origin area M, and thereby determines the exploration area P. Here, the left direction will be selected as the exploration area P. As a result, the rectangular area (B-2-1) becomes the exploration area. In Step S211, the cost calculation unit 120 judges whether or not the exploration area P is located in the upper or lower layer direction. Since the rectangular area (B-2-1) does not correspond to the exploration in the upper or lower layer direction, the process goes to Step S213.

(m) In Step S213, the wiring cost calculation unit 121 calculates the cost based on the information stored in the wiring cost storage unit 21. Since the rectangular area (B-2-1) incurs the “wiring cost for advancing one rectangular area in the horizontal direction in a wiring area in a first layer”, the wiring cost addition unit 121 adds the cost “1” and stores the cost in the program memory 2m.

(n) In Step S217, the cost calculation unit 120 judges whether or not the exploration area P is unexplored. Since the rectangular area (B-2-1) is not unexplored, the process goes to Step S219. In Step S219, the counting unit 124 counts up the costs of the exploration area P calculated by the cost calculation unit 120, and judges whether or not the newly calculated cost is greater than the cost of the exploration area P, which was calculated in the previous exploration. Here, the cost of the rectangular area (B-2-1) as the exploration area P is equal to “2”, which is obtained by adding the wiring cost “1” to the value “1” of the origin area M. Meanwhile, a relation in size between the cost of the exploration area calculated in the previous exploration and the cost of the exploration area calculated in the recent exploration is expressed as 2>0, and the cost of the exploration area calculated in the recent exploration is greater. Accordingly, the process goes to Step S223.

(o) As shown in FIGS. 6A and 6B, the costs of each rectangular area are calculated with the starting point area S as the starting point by sequentially repeating each of the Steps S205 to S223. Eventually, the position of the starting point area S coincides with the position of the ending point area E in Step S207, and the cost calculation of each rectangular area in the wiring areas is completed as shown in FIGS. 7A and 7B In Step S300 of FIG. 3, the connection unit 130 of FIG. 1 connects the starting point area S to the ending point area E as shown in FIGS. 8A and 8B based on the information on the wiring path achieving the lowest cost, which has been explored by the path finding unit 110, thereby installing the lines M. The via arrangement unit 140 arranges the vias V1 and V2, to which the lines M are connected, respectively. In Step S400, the via arrangement unit 140 replaces the vias V1 and V2 with the multiple cut vias V3 and V4 as shown in FIGS. 9A and 9B. Then, the operation is completed.

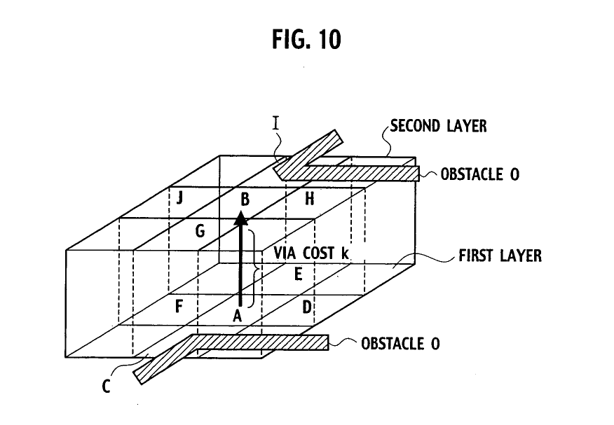

A method of calculating the costs by use of the computer automated design method according to the first embodiment will be described with reference to a schematic diagram shown in FIG. 10. According to the computer automated design method according to the first embodiment, in the case of finding the wiring path from an area A in the wiring area in the first layer to an area B in the wiring area in the second layer shown in FIG. 10, a wiring cost is multiplied by a via cost k (k is a constant greater than 1). By multiplying the wiring cost by the via cost k, the cost of the area B is calculated as a higher value. Accordingly, the area B located in the upper layer of the area A is less likely to be selected as the path achieving the lowest cost. As a result, path finding toward a different layer is often avoided, and the generation rate of vias is thereby reduced. As shown in FIGS. 9A and 9B, when there is an intention to arrange a plurality of vias in the wiring areas, it is possible to design the arrangement of the vias in areas less congested with the lines by setting a large via cost value k in response to the number, size, and shape of the vias. In this way, it is possible to increase the replacement rate of the multiple cut vias.

Meanwhile, when the obstacles (existing lines) O exist in an area C and an area I among areas C, D, E, and F, which are adjacent to the area A, and areas G, H, I, and J, which are adjacent to the area B, the cost of the area B is calculated as a higher value by adding the cost of the area C and area I as an obstacle cost for performing an exploration from the area A to the area B. By calculating the cost of the area congested with the lines as a high value, the vias are less likely to be arranged in the area congested with the lines. Accordingly, it is possible to arrange the vias in the area in which the lines are not congested, and thereby to increase the replacement rate of the multiple cut vias. By increasing the replacement rate of the multiple cut vias, it is possible to suppress a reduction in yields attributable to defective vias. In this way, it is also possible to provide semiconductor integrated circuits in high yields. In the example shown in FIGS. 4A to 10, the obstacle cost is added when there is an obstacle in a rectangular area adjacent to any of four sides defining the periphery of the exploration area P. However, the addition of the obstacle cost is not limited only to the information on the rectangular areas adjacent to the exploration area P, and it is also possible to perform an exploration while considering the information on the obstacles in a wider range.

The series of automated design processes shown in the flowcharts of FIGS. 2 and 3 can be executed by controlling the computer system (the computer automated design system) shown in FIG. 1 by use of a program having an algorithm equivalent to FIGS. 2 and 3. Such a program may be stored in the program memory 2m shown in FIG. 1. The program configured to be executed by a computer for executing an application on a computer automated design system includes:

(a) storing a rectangular area serving as a starting point area S of a wiring and storing a rectangular area serving as an ending point area E of the wiring in the rectangular area list storage unit 25, the rectangular areas being selected from wiring areas in a plurality of layers each divided into a plurality of areas by a lattice;

(b) adding a wiring cost whenever an exploration of a wiring path from the starting point area to the ending point area advances one rectangular area by the wiring cost addition unit 121;

(c) multiplying the wiring cost by a via cost to provide a multiple cut via in any of the wiring areas in the plurality of layers by the via cost multiplication unit 122;

(d) adding an obstacle cost based on obstacle information to a result of multiplication of the via cost by the obstacle cost addition unit 123;

(e) counting up the cost calculated by the wiring cost addition unit 121, the via cost multiplication unit 122, and the obstacle cost addition unit 123 and storing count up result in the the rectangular area list storage unit 25 by the counting unit 124:

(f) finding the wiring path in the wiring areas in the plurality of layers based on the count up result by the path finding unit 110;

(g) connecting the starting point area and the ending point area by the connection unit 124; and

(h) arranging the multiple cut via in any of the wiring areas in the plurality of layers by the via arrangement unit 140.

It is also possible to execute the series of automated design processes of the automated design according to the first embodiment by saving an automated design program of the first embodiment in a computer-readable recording medium and causing the program memory 2m to read this recording medium. The “computer-readable recording medium” indicates any medium such as an external memory device of a computer, a semiconductor memory, a magnetic disk, an optical disk, a magneto-optical disk, or a magnetic tape which can record a program, for example. To be more precise, the “computer-readable recording medium” includes a flexible disk, a CD-ROM, an MO disk, and the like. For example, a main body of a computer system may be configured to incorporate or externally connect a flexible disk device (a flexible disk drive) or an optical disk device (an optical disk drive). By inserting a flexible disk from an inlet of the flexible disk drive or a CD-ROM from an inlet of the optical disk drive, and performing a given reading operation, it is possible to install the program stored in these media into the program memory 2m constituting the computer system. Moreover, it is possible to store this program in the program memory 2m through an information processing network such as the Internet.

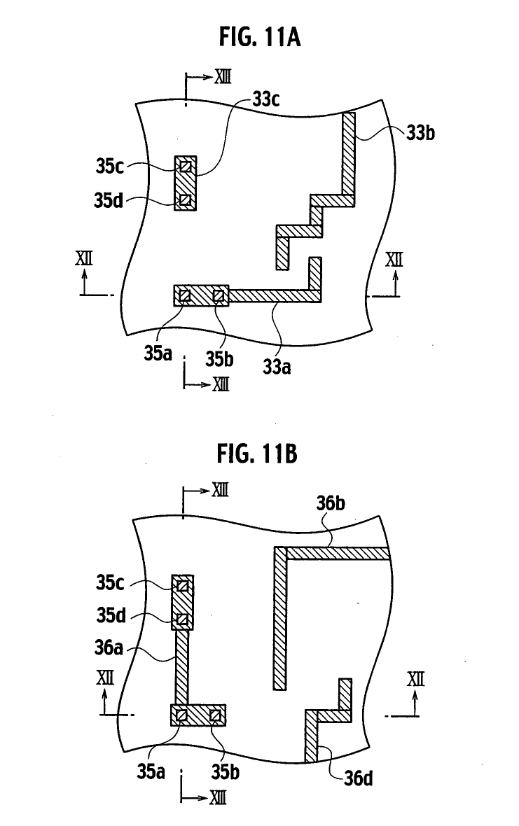

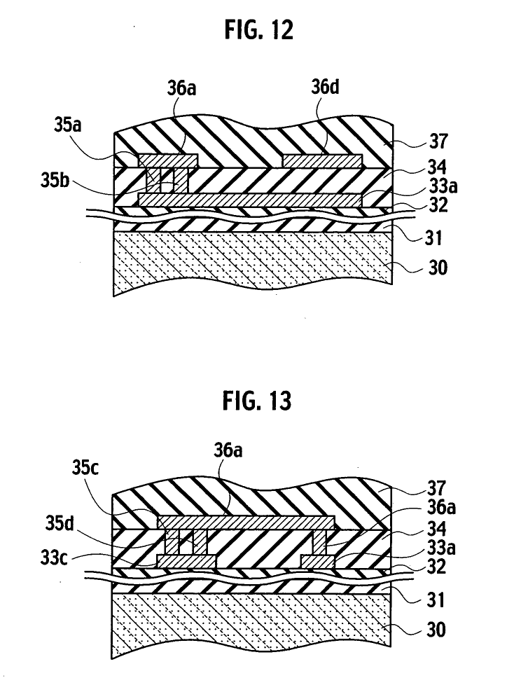

FIGS. 11A to 13 illustrate part of a semiconductor integrated circuit subjected to the automated arrangement of lines and vias in two wiring layers in accordance with the flowcharts shown in FIGS. 2 and 3. FIG. 11A is a plan view from the viewpoint of the upper face where a k-th line 33a of FIG. 12 is located, and FIG. 11B is a plan view from the viewpoint of the upper face where k+1-th lines 36a and 36d of FIG. 12 are located FIG. 12 is a cross-sectional view taken on line XII-XII in FIGS. 11A and 11B, and FIG. 13 is a cross-sectional view taken on line XIII-XIII in FIGS. 11A and 11B.

The semiconductor integrated circuit shown in FIGS. 11A to 13, in practice, is fabricated by use of a pattern generator such as an ion beam exposure apparatus, and manufacturing masks (such as reticles) used for actual manufacturing of the semiconductor integrated circuit based on layout information produced with the computer automated design system (a CAD system) in accordance with the flowcharts shown in FIGS. 2 and 3. The manufacturing masks at least include manufacturing masks required for manufacturing elements for constructing macro cells and logic cells (logic elements), manufacturing masks required for manufacturing power lines, signal lines, and the like of a first line, a manufacturing mask required for manufacturing the k-th line 33a, a manufacturing mask required for opening via holes in a k-th inter layer insulating film 34 between the k-th line 33a and the k+1-th line 36a, and a manufacturing mask required for manufacturing the k+1-th line 36a. Moreover, it is possible to manufacture the semiconductor integrated circuit as shown in FIGS. 11A to 13 by applying the set of these multiple manufacturing masks to an exposure apparatus (a stepper), carrying out photolithography processes of each stage, and combining various semiconductor manufacturing processes including the photolithography processes, ion implantation, reactive ion etching (RIE), CVD, sputtering, and the like.

As shown in FIG. 12, the semiconductor integrated circuit according to the first embodiment includes a semiconductor substrate 30, a first interlayer insulating film 31 stacked on the semiconductor substrate 30, and a k−1-th interlayer insulating film 32 disposed as an upper layer of the first interlayer insulating film 31. The k-th line 33a is disposed on the k−1-th interlayer insulating film 32. The k-th interlayer insulating film 34 is disposed on the k-th line 33a. Two via plugs 35a and 35b connected to terminal portions of the k-th line 33a are buried in the k-th interlayer insulating film 34. The k+1-th line 36a connected to the via plugs 35a and 35b, and the k+1-th line 36d disposed away from the k+1-th line 36a are disposed on the k-th interlayer insulating film 34. A k+1-th interlayer insulating film 37 is disposed on the k+1-th lines 36a and 36d.

As shown in FIG. 11A, in the layer where the k-th line 33a is disposed, k-th lines 33b and 33c are also disposed away from the k-th line 33a, respectively. Via plugs 35c and 35d are disposed on the k-th line 33c. As shown in FIG. 12, the k-th line 33c is connected to an end of the k+1-th line 36a in the upper layer through these via plugs 35c and 35d. As shown in FIG. 11B, the via plugs 35a and 35b are disposed on the other end of the k+1-th line 36a. As shown in FIG. 12, an end of the k-th line 33a is connected to lower ends of the via plugs 35a and 35b.

As shown in FIGS. 11A and 11B, according to the semiconductor integrated circuit of the first embodiment of the present invention, the plurality of vias (the multiple cut vias) are arranged in the areas which are not adjacent to the lines. Therefore, the occurrence of an increase in resistance or disconnection attributable to a damaged via is reduced in comparison with the case of arranging a single via. In this way, it is possible to provide semiconductor integrated circuits in high yields.

### Second Embodiment

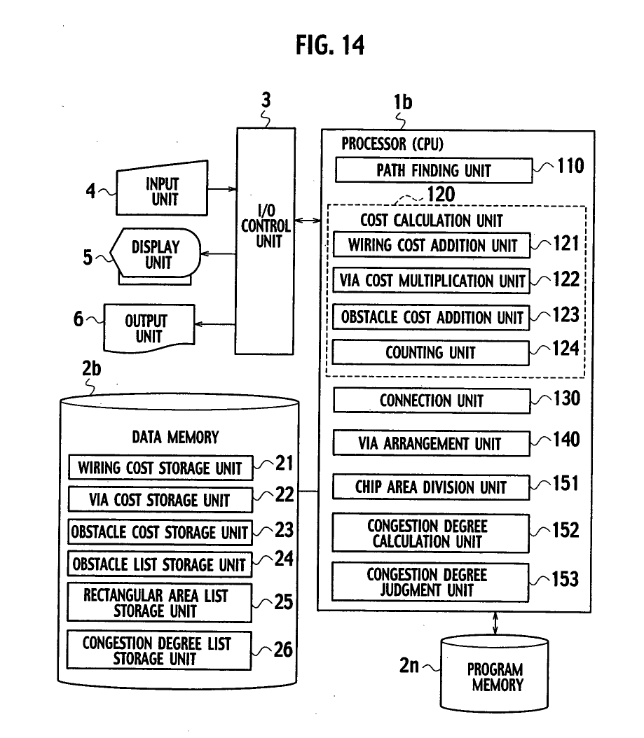

As shown in FIG. 14, a computer automated design system according to a second embodiment of the present invention includes an input unit 4 which inputs information such as data or instructions from an operator, a central processing unit (CPU) 1b which executes various calculations such as layout design, a display unit 5 and an output unit 6 which outputs a layout result and the like, a data memory 2b which stores given data and the like necessary for layout design of a semiconductor integrated circuit, and a program memory 2n which stores a layout program and the like for the semiconductor integrated circuit. The input unit 4, the display unit 5, and the output unit 6 are connected to the CPU 1b through an input and output control unit 3.

A CPU 1b includes a path finding unit 110, a cost calculation unit 120, a connection unit 130, a via arrangement unit 140, a chip area division unit 151, a congestion degree calculation unit 152, and a congestion degree judgment unit 153.

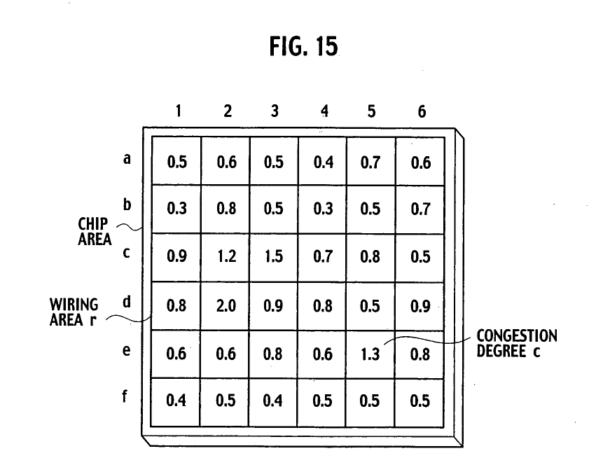

As shown in FIG. 15, the chip area division unit 151 divides a chip area located virtually inside a memory space of a computer automated design system into a plurality of wiring areas r based on information for dividing the chip area stored in a program memory 2n and the like. The congestion degree calculation unit 152 calculates congestion degrees of lines in each of the wiring areas r based on information for calculating congestion degrees of the lines stored in the program memory 2n and the like, and stores the congestion degrees in a congestion degree list storage unit 26. The congestion degree judgment unit 153 determines a wiring path finding method to be performed by the path finding unit 110 based on the information on the congestion degrees of each area stored in the congestion degree list storage unit 26.

A data memory 2b includes a wiring cost storage unit 21, a via cost storage unit 22, an obstacle cost storage unit 23, an obstacle list storage unit 24, a rectangular area list storage unit 25, and the congestion degree list storage unit 26. The congestion degree list storage unit 26 stores the information on the congestion degrees of the lines calculated by the congestion degree calculation unit 152. Since other features are substantially similar to those in the first embodiment, a description thereof will be omitted.

Next, a computer automated design method according to the second embodiment will be described with reference to FIGS. 14 to 19B.

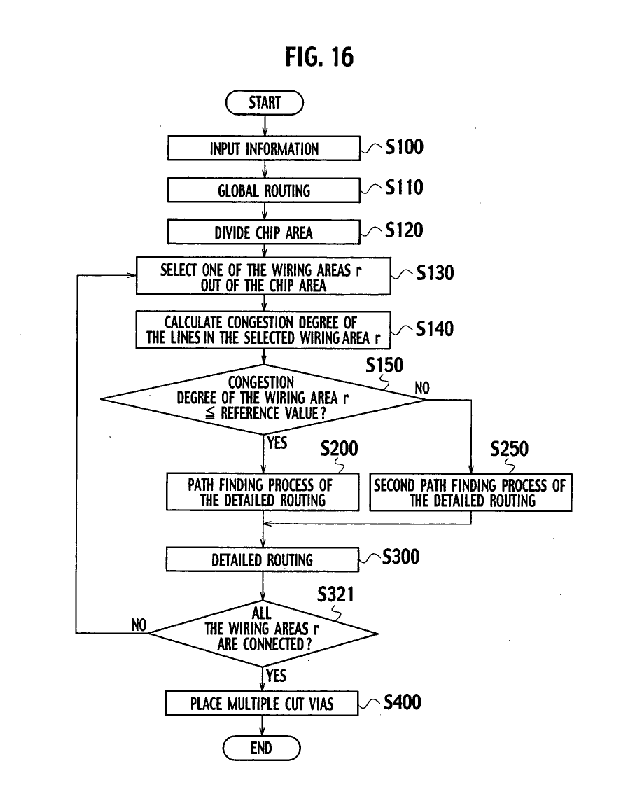

(a) In Step S100 of FIG. 16, the various information, which is necessary for the computer automated design system shown in FIG. 14 to execute an automated design process, is input by use of an input unit 4. For example, the information for allowing the computer automated design system shown FIG. 14 to process global routing on the chip area inside the memory space, the information for dividing the chip area into the plurality of areas, the information for calculating the congestion degrees of the lines, default values of the congestion degrees of the lines, information for the execution of wiring path finding in accordance with the maze routing, and the like is stored in the data memory 2b and the like by use of the input unit 4.

(b) In Step S110, the computer automated design system of FIG. 14 processes global routing on the chip area based on the information stored in the data memory 2b and the program memory 2n. In Step S120, the chip area division unit 151 divides the chip area in to the plurality of wiring areas r as shown in FIG. 15, based on the information stored in the program memory 2n and the like. In FIG. 15, for the purpose of explanation, codes 1 to 6 are allocated in the horizontal direction of each area in the chip area, and codes a to f are allocated in the vertical direction thereof. In the following, position information on each area will be indicated in the order of “a wiring area r (position in the horizontal direction—position in the vertical direction)”.

(c) The congestion degree calculation unit 152 selects one of the wiring areas r out of the chip area shown in FIG. 15 in Step S130, and calculates the congestion degree of the lines in the selected wiring area r in Step S140. Here, the values shown in FIG. 15 are examples of numerical values showing the congestion degrees, and the method of calculating the congestion degrees is not particularly limited. For example, the congestion degrees of the lines may be calculated based on the global routing in Step S110, or based on a resource number of detailed routing or on a predicted rectangular area number to be consumed by the detailed routing, which will be described later. Information on a result of calculation by the congestion degree calculation unit 152 is stored in the congestion degree list storage unit 26.

(d) In Step S150, the congestion degree judgment unit 153 judges whether or not the congestion degree of the wiring area r calculated by the congestion degree calculation unit 152 is equal to or below a reference value stored in advance in the data memory 2b and the like. The process goes to Step S200 when the congestion degree of the wiring area r is equal to or below the reference value, and the process goes to Step S250 when the congestion degree exceeds the reference value. For example, the reference value is assumed to be preset to 1.0 in the example of FIG. 15. Here, when the congestion degree calculation unit 152 selects the wiring areas r (c-1), (c-3), (d-2), and (e-5), the process goes to Step S250 because the congestion degrees of these wiring areas r exceed the reference value. When the congestion degree calculation unit 152 selects any other wiring areas r, the process goes to Step S200 because the congestion degrees fall below the reference value.

(e) In Step S200, a path finding process of the detailed routing is carried out. Since Step S200 is substantially similar to the mode shown in FIG. 2, a description thereof will be omitted Step S250 will be described later. In Step S300, the connection unit 130 of FIG. 14 connects a line based on information on the wiring path achieving the lowest cost, which has been explored by the path finding unit 110. In Step S321, the connection unit 130 judges whether or not all the wiring areas r in the chip area are connected. The process goes to Step S130 when there still remains wiring areas r which are not connected. When all the areas r are connected, the process goes to Step S400 where the via arrangement unit 140 arranges single cut vias or multiple cut vias. In this way, the operation is completed.

—Second Path Finding Process (Details of Step S250)—

Next, a second path finding process shown in Step S250 will be described. Step S250 is different from the routing method shown in Step S200 in which a finding method not in consideration of replacement with multiple cut vias is used as the wiring path finding method in accordance with the maze routing. Since other features are substantially similar to Step S200, a detailed description thereof will be omitted.

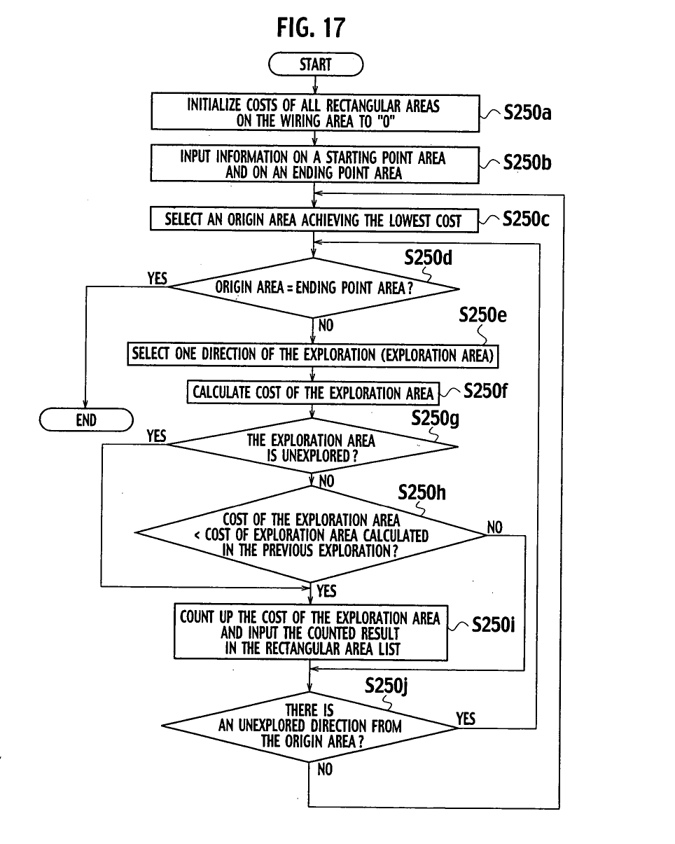

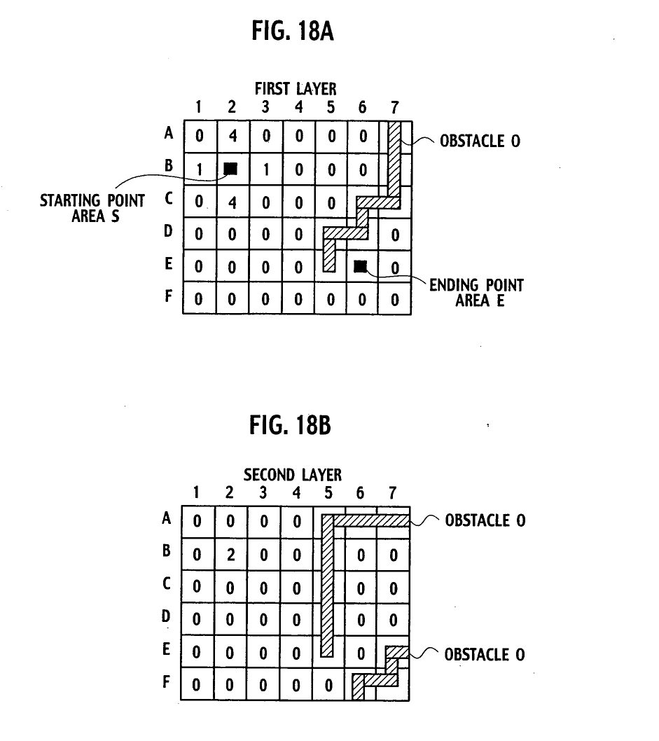

(a) In Step S250a of FIG. 17, the costs of all rectangular areas on the wiring area are initialized to “0”. In Step S250b, information on a starting point area S constituting a starting point of an exploration and information on an ending point area E constituting an ending point of the exploration is stored in the rectangular area list storage unit 25 of FIG. 14 by use of the input unit 4 and the like. In the example of FIG. 18A, position information on the rectangular area (B-2-1) is stored as the starting point area S and position information on the rectangular area (E-6-1) is stored as the ending point area E.

(b) In Step S250c, the path finding unit 110 of FIG. 14 selects an origin area M achieving the lowest cost based on the information stored in the rectangular area list storage unit 25. At this point, the rectangular area list storage unit 25 stores only the information on the starting point area S and the ending point area E. The path finding unit 110 selects the starting point area S, namely the rectangular area (B-2-1), as the origin area M. In Step S250d, the path finding unit 110 judges whether or not the origin area M coincides with the ending point area E. Since the rectangular area (B-2-1) of the origin area M is different from the rectangular area (E-6-1) of the ending point area E as shown in FIGS. 18A and 18B, the process goes to Step S250e.

(c) In Step S250e, the path finding unit 110 selects one direction of the exploration (an exploration area P) to be started from the origin area M. In FIGS. 18A and 18B, any one of the right direction, the left direction, the upper direction, the lower direction, and the direction to the upper layer is conceivable as the direction of the exploration to be started from the rectangular area (B-2-1). Here, the right direction will be selected as the exploration area P. As a result, the rectangular area (B-3-1) becomes the exploration area P. In Step S250f, the cost calculation unit 120 calculates a wiring cost of the exploration area P based on cost information stored in the data memory 2b. Note that a via cost and an obstacle cost are not considered in Step 250f, unlike in the mode shown Step S200 which has been described in the first embodiment. As shown in FIGS. 18A and 18B, the rectangular area (B-3-1) incurs the “wiring cost for advancing one rectangular area in the horizontal direction in a wiring area in a first layer” from the viewpoint of the origin area M. Therefore, the wiring cost addition unit 121 adds the cost “1” as the wiring cost and stores the cost in the program memory 2n.

(d) In Step S250g, the cost calculation unit 120 judges whether or not the exploration area P is unexplored. The process goes to Step S250i when the exploration area P is unexplored, and the process goes to Step S250h when the exploration area P is not unexplored. In Step S250h, the counting unit 124 counts up the costs of the exploration area P calculated by the cost calculation unit 120, and judges whether or not the newly calculated cost is greater than the cost of the exploration area P, which was calculated in the previous exploration. The process goes to Step S250i when the newly calculated cost is smaller than the cost of the exploration area which was calculated in the previous exploration, and the process goes to Step S250j when the exploration area P is greater than the cost of the exploration area which was calculated in the previous exploration.

Here, since the rectangular area (B-3-1) is unexplored, the process goes to Step S250i. In Step S250i, a counting unit 124 adds the wiring cost and the like of the exploration area P and the like stored in the program memory 2n to the cost of the origin area M, and stores the added value in the rectangular area list storage unit 25. Here, the cost of the rectangular area (B-3-1) is equal to “1”, which is obtained by adding the wiring cost “1” to the value “0” of the starting point area S. As shown in FIG. 18A, the counting unit 124 stores the value “1” in an area of the rectangular area list storage unit 25, the area corresponding to the rectangular area (B-3-1).

(e) In Step S250j, the path finding unit 110 judges whether or not there is an unexplored direction from the origin area M. The process goes to Step S250d when there is an unexplored direction, and the process goes to Step S250c when there is not an unexplored direction. Since the rectangular area (B-3-1) is the only area explored as the exploration area Pat this point, the process goes to Step S250d. Thereafter, in Step S250e, the path finding unit 110 selects another direction of the exploration (the exploration area P) to be started from the origin area M. Here, the path finding unit 110 is assumed to select the rectangular area (B-2-2) in the direction of the upper layer as the direction of the exploration from the rectangular area (B-2-1).

(g) In Step S250f, the cost calculation unit 120 calculates the wiring cost of the exploration area P based on the cost information stored in the data memory 2b. Since the rectangular area (B-2-2) of the exploration area P incurs the “wiring cost for advancing one rectangular area to a different layer”, the wiring cost addition unit 121 adds the cost “2” and stores the cost in the program memory 2n and the like.

(h) In Step S250g, the cost calculation unit 120 judges whether or not the exploration area P is unexplored. Since the rectangular area (B-2-2) is unexplored, the process goes to Step S250i. In Step S250i, the counting unit 124 adds the cost of the exploration area P calculated by the cost calculation unit 120 to the cost of the origin area M, and stores the added value in the rectangular area list storage unit 25. Here, the cost of the rectangular area (B-2-2) to be stored in the program memory 2n is equal to “2”, which is obtained by adding the wiring cost “2” to the value “0“ of the starting point area S. As shown in FIG. 18B, the counting unit 124 stores information on the cost “2” in an area of the rectangular area list storage unit 25, the area corresponding to the rectangular area (B-2-2)

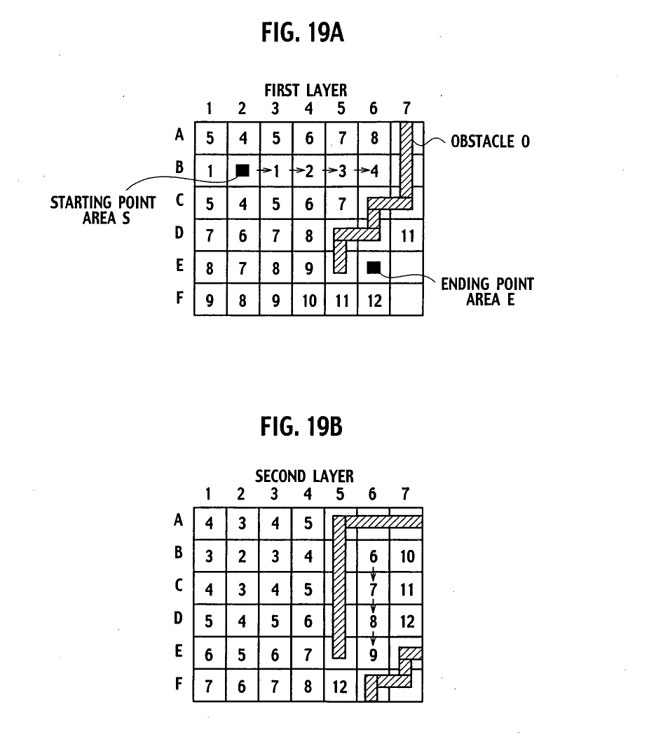

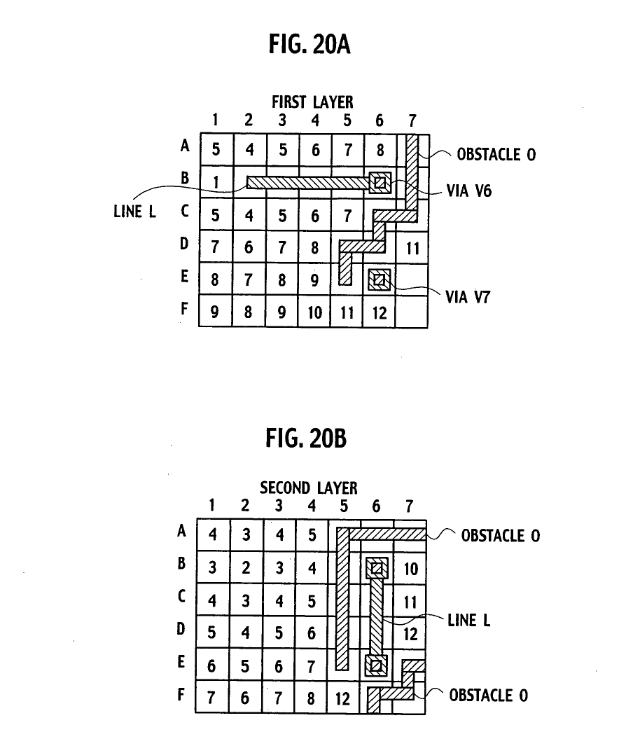

(i) In Step S250j, the path finding unit 110 judges whether or not there is an unexplored direction from the origin area M. Since the rectangular area (B-3-1) and the rectangular area (B-2-2) are the only areas explored as the exploration areas P at this point, there are still unexplored direction. Accordingly, the process goes to Step S250d. Likewise, each of the Steps S250d to S250j is repeated, and the process goes to Step S250c when there are no more unexplored directions. In this way, it is possible to obtain cost information as shown in FIGS. 19A and 19B by repeating each of the Steps S250c to 250j. At this time, the path achieving the lowest cost is drawn as a sequence of the rectangular areas (B-2-1), (B-3-1), (B-4-1), (B-5-1), (B-6-1), (B-6-2), (C-6-2), (D-6-2), and (E-6-2) as indicated with arrows in FIGS. 19A and 19B. By arranging the lines and the vias based on the lowest cost path, layouts as shown in FIGS. 20A and 20B are obtained.

The mode described in Step S200 in the first embodiment requires more wiring resources as compared to the case of using the general maze routing, since the path in consideration of replacement with the multiple cut vias is to be found. Accordingly, it is difficult to design the wiring in consideration of replacement with the multiple cut vias in an area having a large congestion degree of wiring. Therefore, in the second embodiment, the wiring path finding process f (Step S200) considering replacement with the multiple cut vias is used for an area having a low congestion degree of wiring, while the second wiring path finding process (Step S250) considering replacement with the single cut vias is selectively used for an area having a high congestion degree of wiring. In this way, it is possible to improve a replacement rate of the multiple cut vias without sacrificing wiring possibilities. As a reduction in yields attributable to defective vias is suppressed by increasing the replacement rate of the multiple cut vias, it is possible to provide semiconductor integrated circuits in higher yields.

The series of computer automated design processes shown in the flowcharts of FIGS. 16 and 17 can be executed by controlling the computer system (the computer automated design system) shown in FIG. 14 by use of a program having an algorithm equivalent to FIGS. 16 and 17. Such a program may be stored in the program memory 2n shown in FIG. 16. The program executed by a computer for executing an application on the computer automated design system according to the second embodiment of the present invention includes:

(a) dividing a chip area into the plurality of wiring areas r by the chip area division unit

(b) calculating a congestion degree of lines in a specific wiring area r among the plurality of wiring areas r by the congestion degree calculation unit 152;

(c) judging whether or not the path finding process for arranging multiple via cuts is processed to the specific wiring area r, based on the result of calculating the congestion degree of lines in the specific wiring area r by the congestion degree judgment unit 153;

(d) storing a rectangular area serving as a starting point area of a wiring and storing a rectangular area serving as an ending point area of the wiring in the rectangular area list storage unit 25,

(e) adding a wiring cost whenever an exploration of a wiring path from the starting point area to the ending point area advances one rectangular area by the wiring cost addition unit 121;

(f) multiplying the wiring cost by a via cost to provide a multiple cut via in any of the wiring areas in the plurality of layers by the via cost multiplication unit 122;

(g) adding an obstacle cost based on obstacle information to a result of multiplication of the via cost by the obstacle cost addition unit 123

(h) counting up the cost calculated by the wiring cost addition unit 121, the via cost multiplication unit 122, and the obstacle cost addition unit 123 and storing count up result in the the rectangular area list storage unit 25 by the counting unit 124

(i) finding the wiring path in the wiring areas in the plurality of layers based on the count up result by the path finding unit 110;

(j) connecting the starting point area and the ending point area by the connection unit 124; and

(k) arranging the multiple cut via in any of the wiring areas in the plurality of layers by the via arrangement unit 140.

It is also possible to execute the series of automated design processes of the automated design according to the first embodiment by saving an automated design program of the first embodiment in a computer-readable recording medium and causing the program memory 2n to read this recording medium. The “computer-readable recording medium” means any medium described in the first embodiment of the present invention.

### Third Embodiment

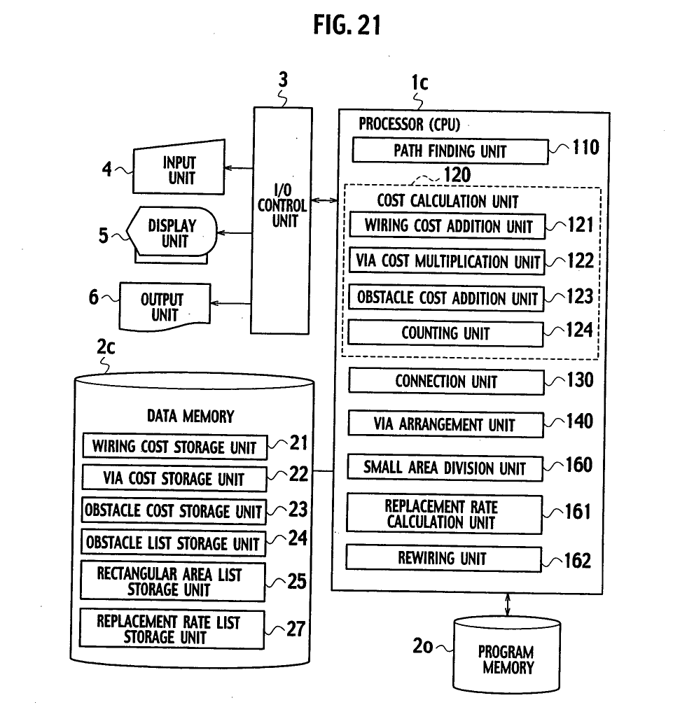

As shown in FIG. 21, a computer automated design system according to a third embodiment of the present invention includes an input unit 4 which accepts inputs such as data or instructions from an operator, a CPU 1c which executes various calculations such as layout design, a display unit 5 and an output unit 6 which output a layout result and the like, a data memory 2c which stores given data and the like necessary for the layout design of a semiconductor integrated circuit, and a program memory 2o which stores a layout program and the like for the semiconductor integrated circuit. The input unit 4, the display unit 5, and the output unit 6 are connected to the CPU 1c through an input and output control unit 3. The CPU 1c includes a path finding unit 110, a cost calculation unit 120, a connection unit 130, a via arrangement unit 140, a small area division unit 160, a replacement rate calculation unit 161, and a rewiring unit 162.

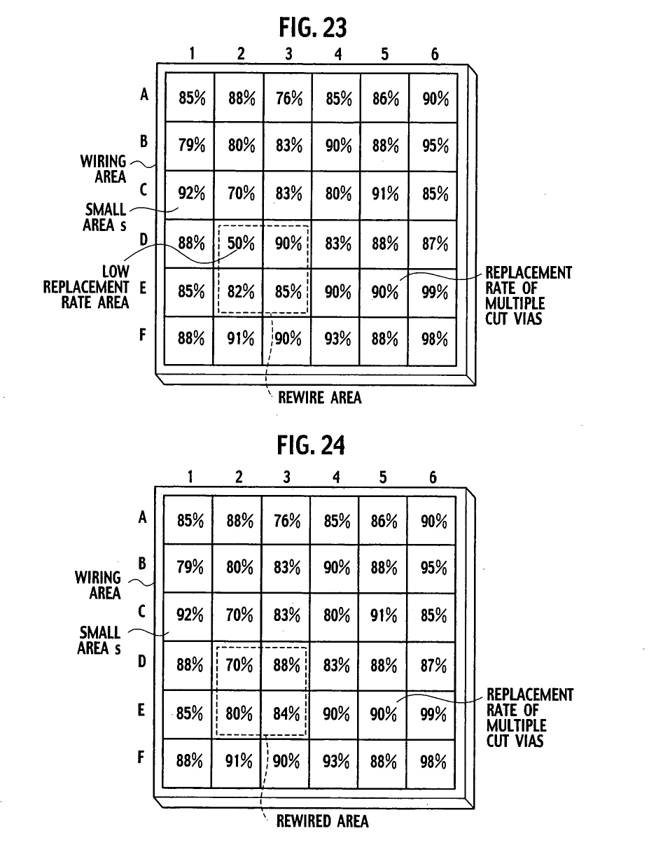

As shown in FIG. 23, the small area division unit 160 divides a wiring area r of a semiconductor integrated circuit located virtually inside a memory space of the computer automated design system into a plurality of small areas s, based on information for dividing the wiring area r into the small areas s, which is stored in the program memory 2o and the like. The replacement rate calculation unit 161 calculates a replacement rate of the small areas s with multiple cut vias based on information for calculating congestion degrees of the lines, which is stored in the program memory 2o and the like, and stores the replacement rate in a replacement rate list storage unit 27. The rewiring unit 162 peels off the lines in the small areas s and rewires lines based on information on the congestion degrees of each small area s stored in the replacement rate list storage unit 27.

The data memory 2c includes a wiring cost storage unit 21, a via cost storage unit 22, an obstacle cost storage unit 23, an obstacle list storage unit 24, a rectangular area list storage unit 25, and the replacement rate list storage unit 27. The replacement rate list storage unit 27 stores the information on the replacement rates of each small area s calculated by the replacement rate calculation unit 161. Other features are substantially similar to those in the first or second embodiment.

Next, a computer automated design method according to the third embodiment will be described with reference to FIGS. 21 to 24.

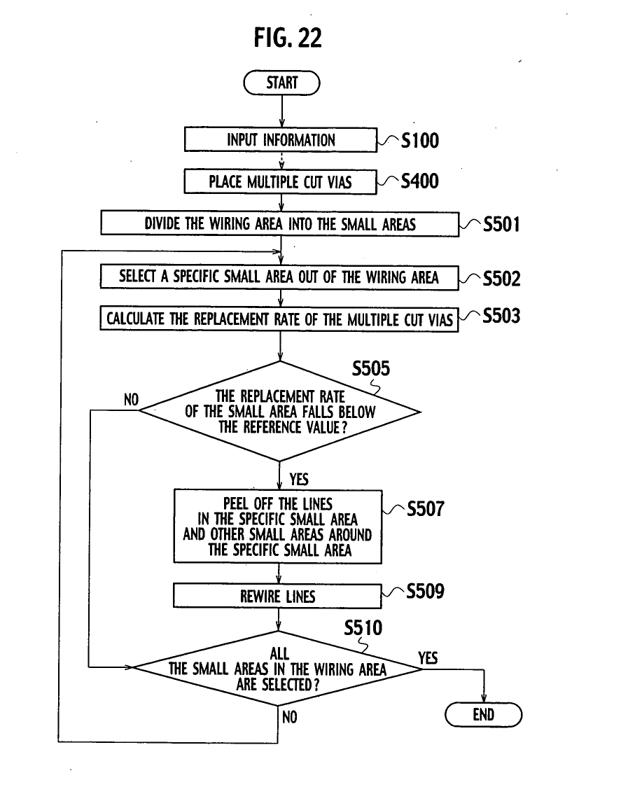

(a) In Step S100 of FIG. 22, the various information, which is necessary for the computer automated design system shown in FIG. 21 to execute a computer automated design process, is input by use of the input unit 4. For example, the information for allowing the computer automated design system shown in FIG. 21 to divide the wiring area r inside the memory space into the plurality of small areas s, the information for calculating the replacement rate of the multiple cut vias, a reference value of the replacement rate, information for the execution of a wiring path finding in accordance with the maze method, and the like is stored in the data memory 2c, the program memory 2o, and the like by use of the input unit 4. Steps 200 to 400 are substantially similar to the procedures described in the first or second embodiment.

(b) In Step S501, the small area division unit 160 of FIG. 21 divides the wiring area r into the small areas s as shown in FIG. 23, based on the information stored in the data memory 2c or the program memory 2o. In FIG. 23, for the purpose of explanation, codes 1 to 6 are allocated in the horizontal direction of each area of the wiring area r, and codes A to F are allocated in the perpendicular direction thereof. In the following, position information in each area will be indicated in the order of “a small area s (position in the horizontal direction—position in the vertical direction)”.

(c) The replacement rate calculation unit 161 selects a specific small area s out of the wiring area r in Step S502, and calculates the replacement rate of the multiple cut vias concerning the small area s in Step S503. The method of calculating the replacement rate in Step S503 is not particularly limited. Information on a result of calculation of the replacement rate is stored in a space for the specific small area s in the replacement rate list storage unit 27 as shown in FIG. 23

(d) In Step S505, the rewiring unit 162 reads the information on the replacement rate stored in the replacement rate list storage unit 27, and judges whether or not the replacement rate of the small area s falls below the reference value. The process goes to Step S507 when the replacement rate falls below the reference value, and the process goes to Step S510 when the replacement rate does not fall below the reference value.

(e) In Step S507, when the replacement rate falls below the reference value, the rewiring unit 162 peels off the lines in the specific small area s and other small areas s around the specific small area s. In the example of FIG. 23, the small area s (D-2) having an extremely low replacement rate (50%) as compared to the surrounding small areas is assumed to be selected as the specific small area s. In Step S507, the rewiring unit 162 peels off the lines in the small area s (D-2) and in the surrounding small areas s (D-3), (E-2), and (E-3). Subsequently, in Step 509, the rewiring unit 162 rewires lines in the small area s (D-2) and the surrounding small areas in accordance with the wiring path finding process described in Step S200 or Step S250. In Step S510, the replacement rate calculation unit 161 judges whether or not all the small areas s in the wiring area r are selected. When there is an unselected small areas, the process goes to Step S502 where the relevant small area s is selected. The operation is completed when all the small areas s have been selected.

According to the computer automated design method according to the third embodiment, as shown in FIG. 23, the rewiring unit 162 rewires the lines in the area having the locally low replacement rate of the multiple cut vias (such as the small area s (D-2)) and in the surrounding areas thereof in accordance with the mode described in the first embodiment. By rewiring the lines in consideration of replacement with the multiple cut vias for the area having the locally low replacement rate, it is possible to improve the replacement rate of the multiple cut vias from 50% to 70% as shown in the small areas (D-2) FIG. 24. As a result, it is possible to increase the replacement rate of the multiple cut vias on the whole semiconductor integrated circuit approximately by 5% to 10%. In this way, it is possible to improve production yields.

The series of automated design processes shown in the flowcharts of FIG. 22 can be executed by controlling the computer system (the computer automated design system) shown in FIG. 21 by use of a program having an algorithm equivalent to FIG. 22. Such a program may be stored in the program memory 20 shown in FIG. 21. The program executed by a computer for executing an application on the computer automated design system according to the second embodiment of the present invention includes:

(a) storing a rectangular area serving as a starting point area S of a wiring and storing a rectangular area serving as an ending point area E of the wiring in the rectangular area list storage unit 25, the rectangular areas being selected from wiring areas in a plurality of layers each divided into a plurality of areas by a lattice;

(b) adding a wiring cost whenever an exploration of a wiring path from the starting point area to the ending point area advances one rectangular area by the wiring cost addition unit 121;

(c) multiplying the wiring cost by a via cost to provide a multiple cut via in any of the wiring areas in the plurality of layers by the via cost multiplication unit 122;

(d) adding an obstacle cost based on obstacle information to a result of multiplication of the via cost by the obstacle cost addition unit 123;

(e) counting up the cost calculated by the wiring cost addition unit 121, the via cost multiplication unit 122, and the obstacle cost addition unit 123 and storing count up result in the the rectangular area list storage unit 25 by the counting unit 124:

(f) finding the wiring path in the wiring areas in the plurality of layers based on the count up result by the path finding unit 110;

(g) connecting the starting point area and the ending point area by the connection unit 124; and

(h) arranging the multiple cut via in any of the wiring areas in the plurality of layers by the via arrangement unit 140.

(i) dividing the wiring area into a plurality of small areas by the small area division unit 160;

(j) calculating a replacement rate of the multiple cut via in terms of a specific small area among the plurality of small areas and storing a result of calculation of the replacement rate in the replacement rate list storage unit 27; and

(k) comparing the result of calculation with a reference value, peeling off lines in the specific small area and in other small areas around the specific small area, and rewiring lines when the result of calculation falls below the reference value.

It is also possible to execute the series of automated design processes of the automated design according to the first embodiment by saving an automated design program of the first embodiment in a computer-readable recording medium and causing the program memory 20 to read this recording medium.

Various modifications will become possible for those skilled in the art after receiving the teachings of the present disclosure without departing from the scope thereof.

What is claimed is:

1. A computer automated design method comprising:
defining rectangular areas serving as a starting point area and an ending point area of a wiring, the rectangular areas being selected from wiring areas assigned in a plurality of layers, each of layers being divided into a plurality of areas by a lattice;
accumulating wiring costs by adding respective wiring cost whenever an exploration of a wiring path from the starting point area to the ending point area advances one rectangular area, multiplying the wiring cost by a via cost, when a multiple cut via is provided between the wiring areas assigned in two of the layers in the plurality of layers, and adding an obstacle cost based on obstacle information to a result of multiplication of the via cost;
finding a final wiring path routing through a plurality of wiring areas in the two of layers based on a value obtained by accumulating the wiring costs to connect the starting point area and the ending point area; and
arranging corresponding multiple cut via in the final wiring path connecting areas in the two of layers.

2. The method of claim 1, wherein a higher cost is added upon addition of the wiring cost when the rectangular area to be explored exists in a different layer of a subject layer, as compared to a case when the rectangular area is located along a wiring preferential direction in the subject layer.

3. The method of claim 1, wherein the via cost is determined based on a shape and a size of the multiple cut via to be arranged in the wiring areas assigned of two of the layers.

4. The method of claim 1, wherein the obstacle cost is determined based on the number of obstacles existing in rectangular areas adjacent to four sides which define the rectangular area to be explored.

5. The method of claim 1, further comprising:
dividing a chip area into the wiring areas; and
calculating a congestion degree of lines in a specific wiring area among the plurality of wiring areas,
wherein finding the wiring path in the wiring areas includes finding the wiring path of the specific wiring area having the congestion degree equal to or below a predetermined value.

6. The method of claim 5, further comprising:
finding the wiring path of the specific wiring area with the congestion degree greater than the predetermined value which is explored not in consideration of replacement with multiple cut vias in accordance with the maze routing.

7. The method of claim 1, further comprising
dividing the wiring area into a plurality of small areas;
calculating a replacement rate of the multiple cut via in terms of a specific small area among the plurality of small areas; and
comparing a result of calculation of the replacement rate with a reference value, peeling off lines in the specific small area and in other small areas around the specific small area, and rewiring lines when the result of calculation falls below the reference value.

8. A program configured to be executed by a computer for executing an application on a computer automated design system, comprising:
defining rectangular areas serving as a starting point area and an ending point area of a wiring, the rectangular areas being selected from wiring areas assigned in a plurality of layers, each of layers being divided into a plurality of areas by a lattice;
accumulating wiring costs by adding respective wiring cost whenever an exploration of a wiring path from the starting point area to the ending point area advances one rectangular area, multiplying the wiring cost by a via cost, when a multiple cut via is provided between the wiring areas assigned in two of the layers in the plurality of layers, and adding an obstacle cost based on obstacle information to a result of multiplication of the via cost;
finding a final wiring path routing through a plurality of wiring areas in the two of layers based on a value obtained by accumulating the wiring costs to connect the starting point area and the ending point area; and
arranging the corresponding multiple cut via in the final wiring path connecting areas in the two of layers.

9. The program of claim 8, wherein a higher cost is added upon addition of the wiring cost when the rectangular area to be explored exists in a different layer of a subject layer, as compared to a case when the rectangular area is located along a wiring preferential direction in the subject layer.

10. The program of claim 8, wherein the via cost is determined based on a shape and a size of the multiple cut via to be arranged in the wiring areas assigned of two of the layers.

11. The program of claim 8, wherein the obstacle cost is determined based on the number of obstacles existing in rectangular areas adjacent to four sides which define the rectangular area to be explored.

12. The program of claim 8, further comprising:
dividing a chip area into the wiring areas; and
calculating a congestion degree of lines in a specific wiring area among the plurality of wiring areas,
wherein finding the wiring path in the wiring areas includes finding the wiring path of the specific wiring area having the congestion degree equal to or below a predetermined value.

13. The program of claim 12, further comprising:
finding the wiring path of the specific wiring area having the congestion degree greater than the predetermined value is explored not in consideration of replacement with multiple cut vias in accordance with the maze routing.

14. The program of claim 8, further comprising dividing the wiring area into a plurality of small areas;
calculating a replacement rate of the multiple cut via in terms of a specific small area among the plurality of small areas; and
comparing a result of calculation of the replacement rate with a reference value, peeling off lines in the specific small area and in other small areas around the specific small area, and rewiring lines when the result of calculation falls below the reference value.

15. A semiconductor integrated circuit manufactured by using a computer automated design method, the method comprising:
defining rectangular areas serving as a starting point area and an ending point area of a wiring, the rectangular areas being selected from wiring areas assigned in a plurality of layers, each of layers being divided into a plurality of areas by a lattice;
accumulating wiring costs by adding respective wiring cost whenever an exploration of a wiring path from the starting point area to the ending point area advances one rectangular area, multiplying the wiring cost by a via cost, when a multiple cut via is provided between the wiring areas assigned in two of the layers in the plurality of layers, and adding an obstacle cost based on obstacle information to a result of multiplication of the via cost;
finding a final wiring path routing through a plurality of wiring areas in the two of layers based on a value obtained by accumulating the wiring costs to connect the starting point area and the ending point area; and
arranging the corresponding multiple cut via in the final wiring path connecting areas in the two of layers.

16. The semiconductor integrated circuit of claim 15, wherein the via cost is determined based on a shape and a size of the multiple cut via to be arranged in the wiring areas assigned of two of the layers.

17. The semiconductor integrated circuit of claim 15, wherein the obstacle cost is determined based on the number of obstacles existing in rectangular areas adjacent to four sides which define the rectangular area to be explored.

18. The semiconductor integrated circuit of claim 15, wherein the method further comprises:
dividing a chip area into the plurality of wiring areas; and
calculating a congestion degree of lines in a specific wiring area among the plurality of wiring areas,
wherein finding the wiring path in the wiring areas includes finding the wiring path of the specific wiring area having the congestion degree equal to or below a predetermined value.

19. The semiconductor integrated circuit of claim 15, wherein the method further comprises:
dividing the wiring area into a plurality of small areas;
calculating a replacement rate of the multiple cut via in terms of a specific small area among the plurality of small areas; and
comparing a result of calculation of the replacement rate with a reference value, peeling off lines in the specific small area and in other small areas around the specific small area, and rewiring lines when the result of calculation falls below the reference value.
